(19) United States
(12) Patent Application Publication
(10) Pub. No.: US 2007/0199179 A1
(43) Pub. Date: Aug. 30, 2007

(54) Hinge with less noise

(76) Inventor: Ting-Hsien Wang, Shulin City (TW)

Correspondence Address: HERSHKOVITZ & ASSOCIATES, 2845 DUKE STREET, ALEXANDRIA, VA, 22314, US

(21) Appl. No.: 11/362,825

(22) Filed: Feb. 28, 2006

(51) Int. Cl. E05D 11/08

(52) U.S. Cl. 16/340

(57) ABSTRACT

A hinge pivotally connects to a cover and a base of an electrical appliance and has a stationary-positioning element, a rotating-positioning element and a buffering spacer. The stationary-positioning element is mounted securely in the base and has at least one positioning protrusion. The rotating-positioning element is mounted securely in the cover and has at least one positioning detent corresponding to the positioning protrusion when the cover is closed. The buffering spacer is attached to the rotating-positioning element to let the stationary-positioning element and the rotating-positioning element in constant contact, which results in friction between the stationary-positioning element and the rotating-positioning element being uniform. Therefore, the hinge as described makes less noise.

### BACKGROUND OF THE INVENTION

1. Field of the Invention

The present invention relates to a hinge, especially to a hinge mounted in an electrical appliance and making less noise.

2. Description of the Prior Arts

Many appliances and electronic devices have a base and a cover, for example notebook computers. A hinge usually pivotally connects the cover to the base to open or close the cover. The conventional hinge comprises a stationary-positioning element, a rotating-positioning element and a biasing member that have features to keep the cover from bumping against the base when the cover is closed. The stationary-positioning element has a detent that is formed in a position to keep the cover from bumping against the base when the cover is closed. The rotating-positioning element rotates relative to the stationary-positioning element and has a protrusion corresponding to the detent when the cover is closed. The biasing member has inherent elasticity and presses the stationary-positioning element against the rotating-positioning element to hold the protrusion in the detent and allow the protrusion to disengage from the detent with the application of a modest force. However, the elasticity of the biasing member is not easy to determine. When the elasticity of the biasing member is too small, the stationary-positioning element and the rotating-positioning element may not be in constant contact, which results in friction between the stationary-positioning element and the rotating-positioning element not being uniform. Therefore, noise is easily generated when the rotating-positioning element rotates relative to the stationary-positioning element. Particularly, when the detent engages the protrusion, the protrusion cannot smoothly slide into the detent because the elasticity of the biasing member is small. Then, noise will also be generated.

To overcome the shortcomings, the present invention provides a hinge with less noise to mitigate or obviate the aforementioned problems.

### SUMMARY OF THE INVENTION

The main objective of the present invention is to provide a hinge with less noise. The hinge with less noise pivotally connects to a cover and a base of an electrical appliance and has a stationary-positioning element, a rotating-positioning element and a buffering spacer. The stationary-positioning element is mounted securely in the base and has at least one positioning protrusion. The rotating-positioning element is mounted securely in the cover and has at least one positioning detent corresponding to the positioning protrusion when the cover is closed. The buffering spacer is attached to the rotating-positioning element to let the stationary-positioning element and the rotating-positioning element in constant contact, which results in friction between the stationary-positioning element and the rotating-positioning element being uniform. Therefore, the hinge as described makes less noise.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a hinge with less noise in accordance with the present invention;

FIG. 2 is an exploded perspective view of the hinge in FIG. 1;

FIG. 3 is another exploded perspective view of the hinge in FIG. 1;

FIG. 4 is a perspective view of a notebook computer with the hinge in FIG. 1;

FIG. 5 is an operational enlarged side view in partial section of the hinge in FIG. 1; and

FIG. 6 is another operational enlarged side view in partial section of the hinge in FIG. 1.

### DETAILED DESCRIPTION OF THE PREFERRED EMBODIMENTS

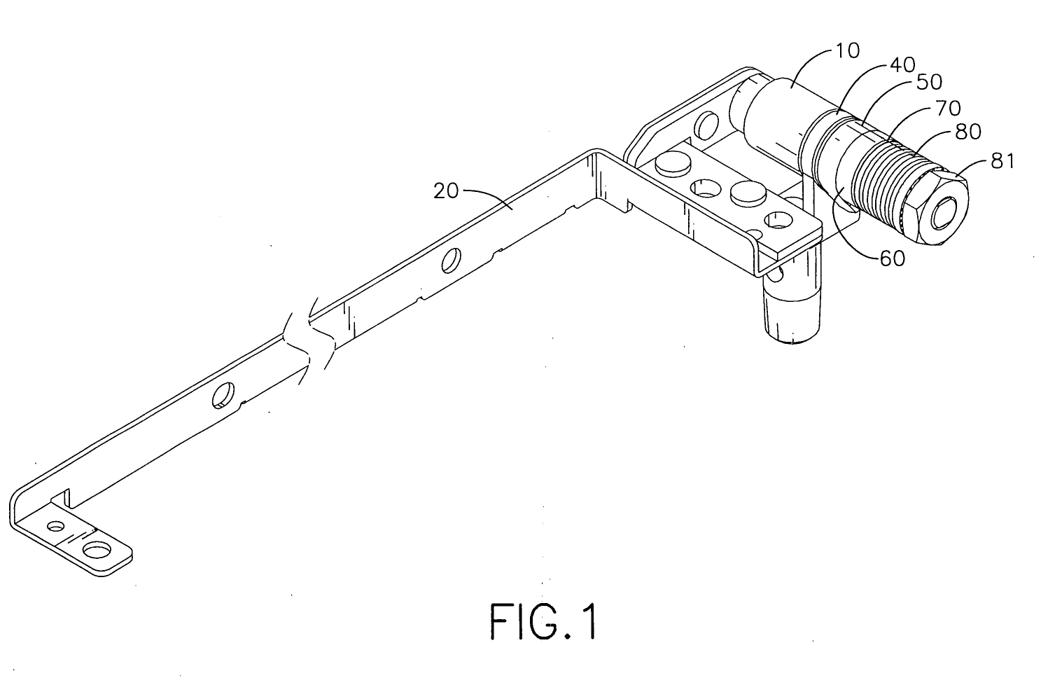

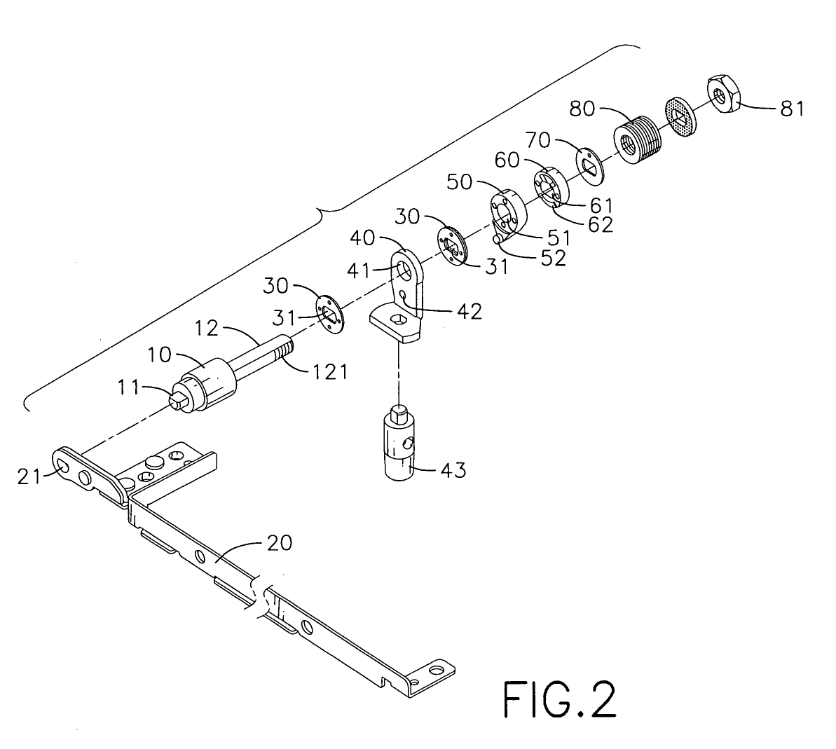

With reference to FIGS. 1 and 2, a hinge with less noise in accordance with the present invention comprises a shaft (10), a rotating bracket (20), a washer assembly (30), a stationary bracket (40), a stationary-positioning element (50), a rotating-positioning element (60), a buffering spacer (70), a biasing member (80) and a fastener (81).

The shaft (10) has a proximal end, a distal end, an optional fastening protrusion (11), an optional extension rod (12) and an optional thread (121). The fastening protrusion (11) is formed axially on the proximal end and is non-circular. The extension rod (12) is formed axially on the distal end and is non-circular. The thread (121) is formed on the extension rod (12).

The rotating bracket (20) is mounted securely on the shaft (10) and may have a through hole (21). The through hole (21) is formed through the rotating bracket (20), is non-circular and engages the fastening protrusion (11) of the shaft (10) to mount the rotating bracket (20) securely on the shaft (10).

The washer assembly (30) is mounted securely on the shaft (10) and has at least one washer. Each washer is mounted securely on the shaft (10) and may have through hole (31). The through hole (31) is formed through the washer, is non-circular and engages the extension rod (12) to mount the rotating bracket (20) securely on the shaft (10).

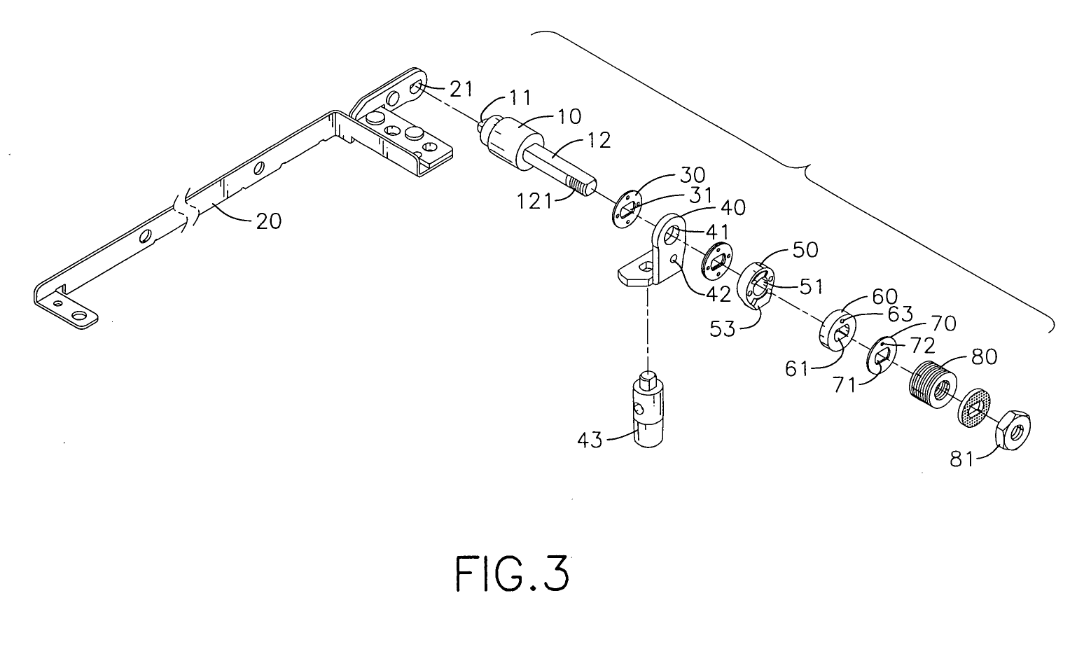

With further reference to FIG. 3, the stationary bracket (40) is mounted around the shaft (10), may be L-shaped and may have a transverse wing, a longitudinal wing, a circular hole (41), a fastening hole (42) and a pin (43). The transverse wing is mounted around the shaft (10). The circular hole (41) is formed through the transverse wing and is mounted around the extension rod (12) of the shaft (10). The fastening hole (42) is formed through the transverse wing. The pin (43) is mounted securely on the longitudinal wing.

The stationary-positioning element (50) is mounted around the shaft (10), is attached to the stationary bracket (40), has a first side, a second side and at least one positioning protrusion (53) and may have a circular hole (51) and a fastening protrusion (52). The at least one positioning protrusion (53) is formed on the second side of the stationary-positioning element (50). The circular hole (51) is formed through the stationary-positioning element (50) and is mounted around the extension rod (12) of the shaft (10). The fastening protrusion (52) is formed on the first side of the stationary-positioning element (50) and extends through the fastening hole (42) of the stationary bracket (40) to attach the stationary-positioning element (50) to the stationary bracket (40).

The rotating-positioning element (60) is mounted on the shaft (10), is mounted adjacent to the stationary-positioning element (50), has a first side, a second side and at least one positioning detent (62) and may have a through hole (61) an a fastening protrusion (63). The at least one detent (62) is formed on the first side of the rotating-positioning element (60) and corresponds to and selectively engages the at least one positioning protrusion of the stationary-positioning element (50). The through hole (61) is formed through the rotating-positioning element (60) is non-circular and engages the extension rod (12) of the shaft (10) to mount the rotating-positioning element (60) on the shaft (10). The fastening protrusion (63) is formed on the second side of the rotating-positioning element (60).

The buffering spacer (70) is mounted on the shaft (10), is mounted adjacent to and is attached to the rotating-positioning element (60) and may have a through hole (71) and a fastening hole (72). The through hole (71) is formed through the buffering spacer (70), is non-circular and engages the extension rod (12) of the shaft (10) to mount the buffering spacer (70) on the shaft (10). The fastening hole (72) is formed through the buffering spacer (70) and engages the fastening protrusion (63) of the rotating-positioning element (60) to attach the buffering spacer (70) to the rotating-positioning element (60).

The biasing member (80) is mounted around the shaft (10). The fastener (81) is mounted on the shaft (10) and may be a nut to screw on the thread (121) of the shaft (10).

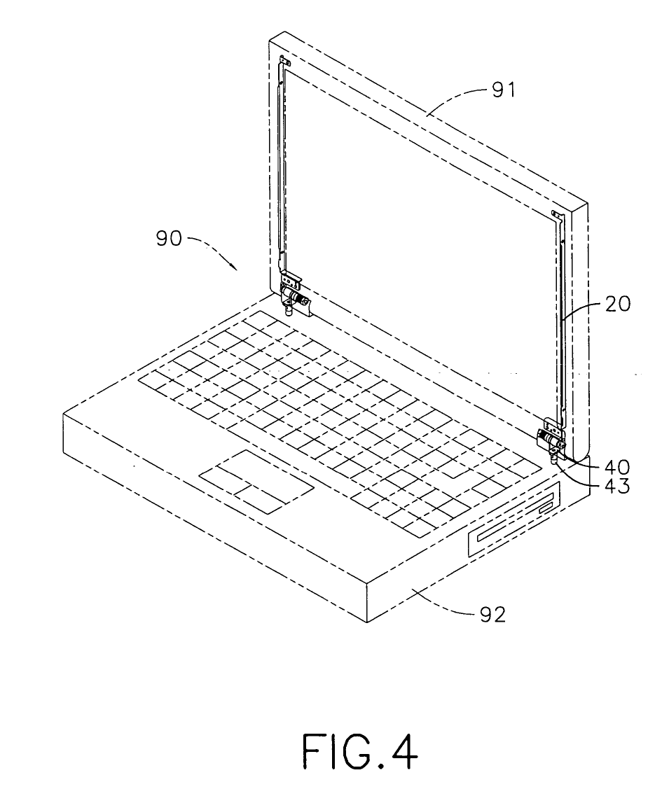

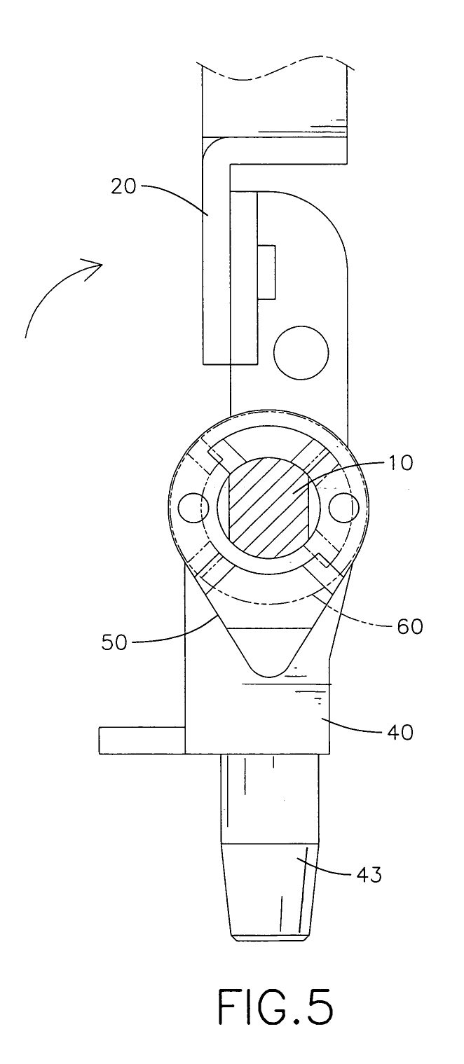

With further reference to FIGS. 4 and 5, an electrical appliance (90) comprises a cover (91) and a base (92). The rotating bracket (20) is attached to the cover (91). The pin (43) of the stationary bracket (40) is attached to the base (92). Because the rotating bracket (20) and the rotating-positioning element (60) are mounted on the shaft (10), the rotating-positioning element (60) is rotated with the shaft (10) when the cover (91) is rotated in relative to the base (92).

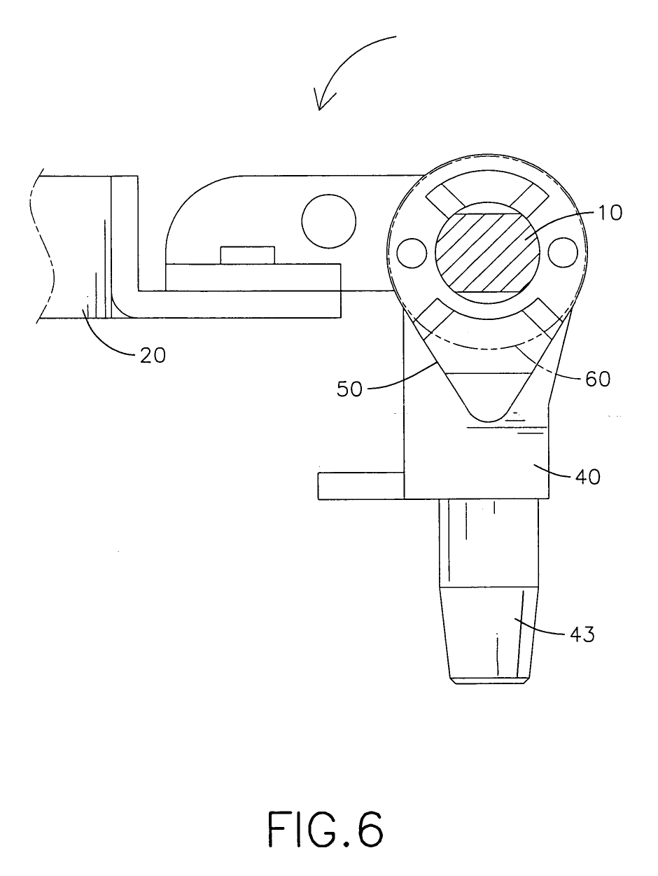

With further reference to FIG. 6, the cover (91) is closed. The positioning protrusion (53) engages the positioning detent (62) to keep the cover (91) from bumping against the base (92).

The buffering spacer (70) effectively let the stationary-positioning element (40) and the rotating-positioning element (50) in constant contact, which results in friction between the stationary-positioning element (40) and the rotating-positioning element (50) being uniform. Therefore, the hinge as described makes less noise.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A hinge comprising:
a shaft having a proximal end and a distal end;
a rotating bracket mounted securely on the shaft;
a washer assembly mounted securely on the shaft and having at least one washer mounted securely on the shaft;
a stationary bracket mounted around the shaft;
a stationary-positioning element mounted around the shaft, attached to the stationary bracket and having
a first side;
a second side; and
at least one positioning protrusion formed on the second side of the stationary-positioning element;
a rotating-positioning element mounted on the shaft, mounted adjacent to the stationary-positioning element and having
a first side;
a second side; and
at least one positioning detent formed on the first side of the rotating-positioning element and corresponding to and selectively engaging the at least one positioning protrusion of the stationary-positioning element;
a buffering spacer mounted on the shaft and mounted adjacent to and is attached to the rotating-positioning element;
a biasing member mounted around the shaft; and
a fastener mounted securely on the shaft.

2. The hinge as claimed in claim 1, wherein
the rotating-positioning element has a fastening protrusion formed on the second side of the rotating-positioning element; and
the buffering spacer has a fastening hole formed through the buffering spacer and engaging the fastening protrusion of the rotating-positioning element.

3. The hinge as claimed in claim 1, wherein
the shaft has a non-circular fastening protrusion formed axially on the proximal end of the shaft; and
the rotating bracket has a non-circular through hole formed through the rotating bracket and engaging the fastening protrusion of the shaft.

4. The hinge as claimed in claim 2, wherein
the shaft has a non-circular fastening protrusion formed axially on the proximal end of the shaft; and
the rotating bracket has a non-circular through hole formed through the rotating bracket and engaging the fastening protrusion of the shaft.

5. The hinge as claimed in claim 1, wherein
the stationary bracket has
a transverse wing mounted around the shaft;
a longitudinal wing; and
a fastening hole formed through the transverse wing; and
the stationary-positioning element has a fastening protrusion formed on the first side of the stationary-positioning element and extending through the fastening hole of the stationary bracket.

6. The hinge as claimed in claim 4, wherein
the stationary bracket has
a transverse wing mounted around the shaft;
a longitudinal wing; and
a fastening hole formed through the transverse wing; and
the stationary-positioning element has a fastening protrusion formed on the first side of the stationary-positioning element and extending through the fastening hole of the stationary bracket.

7. The hinge as claimed in claim 5, wherein the stationary bracket has a pin mounted securely on the longitudinal wing of the stationary bracket.

8. The hinge as claimed in claim 6, wherein the stationary bracket has a pin mounted securely on the longitudinal wing of the stationary bracket.

9. The hinge as claimed in claim 5, wherein
the shaft has a non-circular extension rod formed axially on the distal end of the shaft;
each washer of the washer assembly has a non-circular through hole formed through the washer and engaging the extension rod of the shaft;
the stationary bracket has a circular hole formed through the transverse wing and mounted around the extension rod of the shaft;
the stationary-positioning element has a circular hole formed through the stationary-positioning element and mounted around the extension rod of the shaft;
rotating-positioning element has a non-circular through hole formed through the rotating-positioning element and engaging the extension rod of the shaft; and
the buffering spacer has a non-circular through hole formed through the buffering spacer and engaging the extension rod of the shaft.

10. The hinge as claimed in claim 8, wherein
the shaft has a non-circular extension rod formed axially on the distal end of the shaft;
each washer of the washer assembly has a non-circular through hole formed through the washer and engaging the extension rod of the shaft;
the stationary bracket has a circular hole formed through the transverse wing and mounted around the extension rod of the shaft;
the stationary-positioning element has a circular hole formed through the stationary-positioning element and mounted around the extension rod of the shaft;
rotating-positioning element has a non-circular through hole formed through the rotating-positioning element and engaging the extension rod of the shaft; and
the buffering spacer has a non-circular through hole formed through the buffering spacer and engaging the extension rod of the shaft.

11. The hinge as claimed in claim 9, wherein
the shaft has a thread formed on the extension rod; and
the fastener is a nut to screw on the thread of the shaft.

12. The hinge as claimed in claim 10, wherein
the shaft has a thread formed on the extension rod; and
the fastener is a nut to screw on the thread of the shaft.
